(19) United States
(12) Patent Application Publication
(10) Pub. No.: US 2013/0181448 A1
(43) Pub. Date: Jul. 18, 2013

(54) ELECTRIC ACTUATORS IN AIRCRAFT SYSTEMS

(71) Applicants: Michael E. Larson, Rockford, IL (US); Gary Sasscer, Leaf River, IL (US)

(72) Inventors: Michael E. Larson, Rockford, IL (US); Gary Sasscer, Leaf River, IL (US)

(73) Assignee: HAMILTON SUNDSTRAND CORPORATION, Windsor Locks, CT (US)

(21) Appl. No.: 13/352,053

(22) Filed: Jan. 17, 2012

(51) Int. Cl. B60L 1/00; H02P 9/08; H02K 7/102; H02K 7/18; B64D 41/00; H02K 7/116

(52) U.S. Cl. 290/43; 244/58; 310/83; 307/9.1; 310/77; 290/52

(57) ABSTRACT

An electric actuation system for an emergency power system of an aircraft includes a motor control portion, a motor brake, a motor in electrical communication with the motor control portion, mechanical gearing in mechanical communication with the motor, the mechanical gearing configured to translate rotational motion of the motor into linear motion across at least one axis, and an extension member in mechanical communication with the mechanical gearing, the extension member configured to linearly travel across the at least one axis.

### BACKGROUND OF THE INVENTION

Generally, the present invention is directed to emergency aircraft systems, and more particularly, exemplary embodiments of the present invention are directed to electrical actuators for mechanically actuating emergency aircraft power systems.

Conventionally, aircraft rely on a ram air turbine (RAT) to provide essential electrical and/or hydraulic power to the aircraft in emergency situations such that power to vital aircraft systems may be adequately maintained. Furthermore, hydraulic actuators are typically used to deploy the RAT outside of an aircraft in these situations. The hydraulic actuators, relying on compressed spring forces and a hydraulic circuit or circuits, may push a RAT into a deployed position in response to an emergency signal or operator request. The hydraulic actuators may be relatively complex allowing for redundant safeties, and therefore may have multiple wet seals, grommets, hoses, and other components subject to mechanical stresses or wear during flight and which are prone to leakage.

### BRIEF DESCRIPTION OF THE INVENTION

According to an exemplary embodiment of the present invention, an electric actuation system for a emergency power system of an aircraft includes a motor control portion, a motor in electrical communication with the motor control portion, mechanical gearing in mechanical communication with the motor, the mechanical gearing configured to translate rotational motion of the motor into linear motion across at least one axis, and an extension member in mechanical communication with the mechanical gearing, the extension member configured to linearly travel across the at least one axis.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic of a hydraulic actuator;

FIG. 2 is an isometric view of a hydraulic actuator;

FIG. 3 is an electric actuator system for a emergency aircraft power system, according to an exemplary embodiment of the present invention;

FIG. 4 is an isometric view of a linear electric actuator, according to an exemplary embodiment; and

FIG. 5 is an isometric view of an electrically actuated RAT.

### DETAILED DESCRIPTION OF THE INVENTION

According to exemplary embodiments of the present invention, an actuation system for emergency aircraft power systems is provided with reduced weight and complexity as compared to conventional systems. The technical effects of one or more of embodiments disclosed herein include eliminating potential for hydraulic leakage, an overall reduced weight of aircraft as well as reduced maintenance tasks and simplifying actuator installation by eliminating hydraulic line connections.

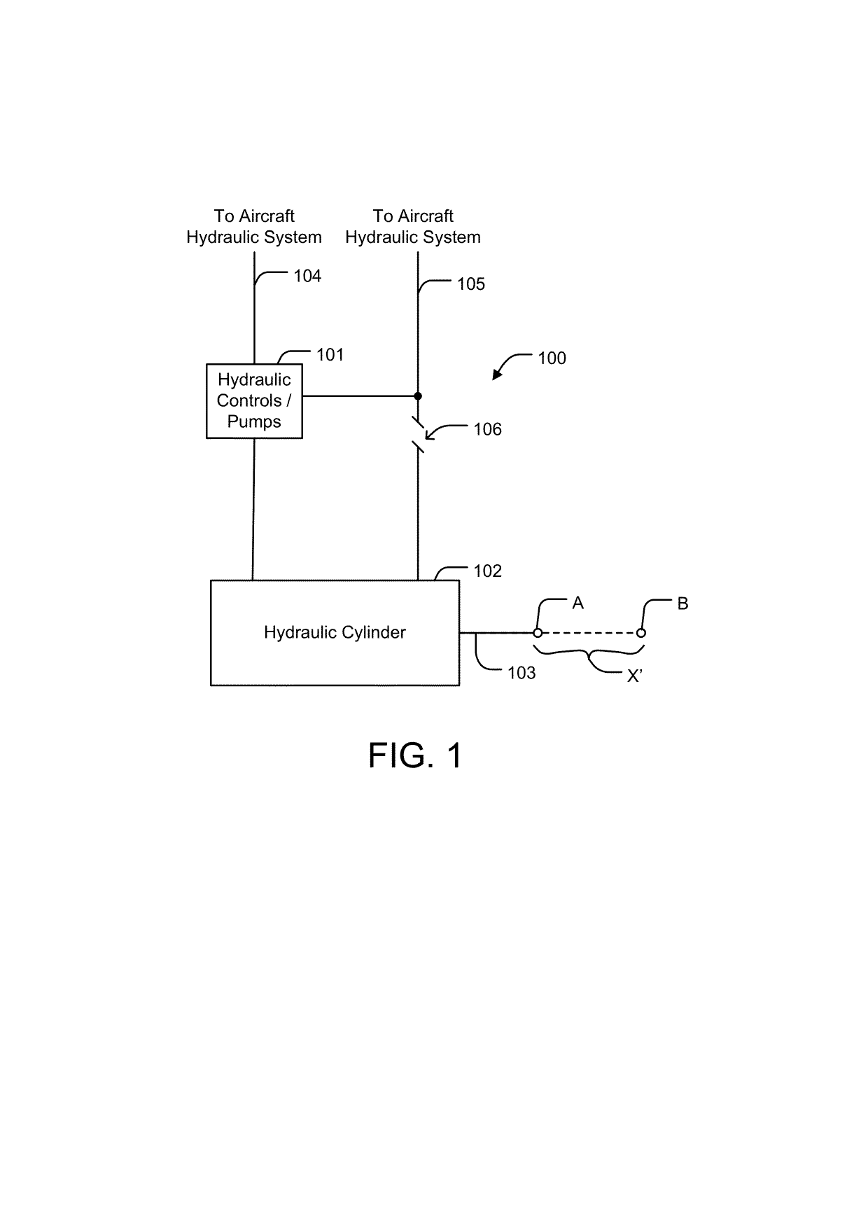

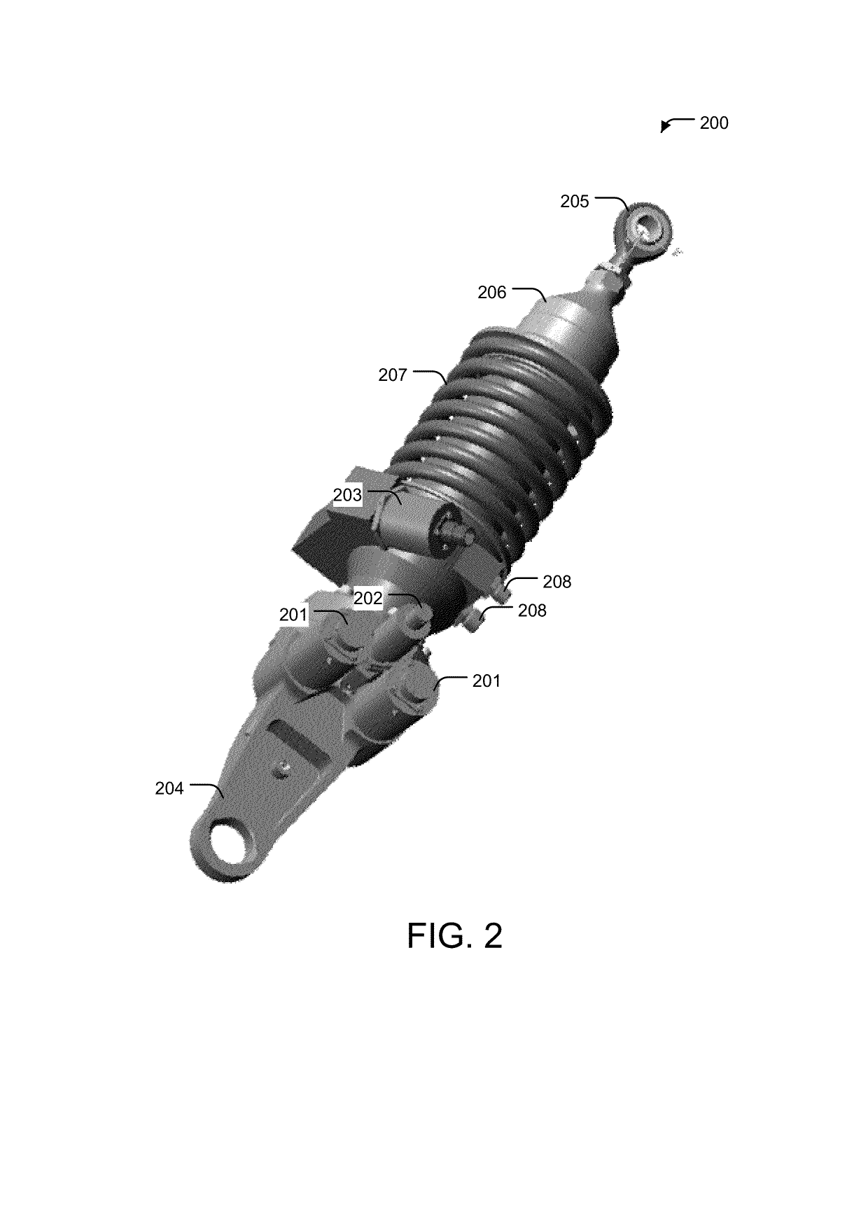

Turning to FIG. 1, a hydraulic actuator 100 is illustrated. As shown, the actuator 100 includes a plurality of hydraulic controls/valves 101 in communication with a hydraulic cylinder 102 over hydraulic lines 104 and 105. Although not particularly illustrated, it should be understood that a plurality of other components 106 may also form a part of the hydraulic actuator including pressure and stow switches, safety and check valves, snubbing orifices, filler caps, and a plurality of other necessary components required to adequately operate the hydraulic actuator 100. The hydraulic actuator 100 includes piston 103 configured to convert hydraulic pressure provided at hydraulic lines 104/105 into linear motion across axis X′, from point A to point B. As a more detailed example, an isometric view of a conventional hydraulic actuator is provided in FIG. 2.

As illustrated, the hydraulic actuator 200 includes two deployment solenoids 201, a pressure valve 202, a retract solenoid 203, a mounting member 204 that remains fixed to an aircraft structure or the RAT frame, a RAT mounting member 205 that moves as the RAT deploys, a hydraulic cylinder 206, a main tension spring 207, and a plurality of hydraulic interface nubs 208. Generally, the hydraulic actuator 200 is substantially similar to hydraulic actuator 100, for example, in that it generally requires connection to the main aircraft hydraulic system to provide fluid to nubs 208 and electric control signals to solenoids 201, 202, and 203. Furthermore, the main compression spring 207 provides constant mechanical forces along an axis of travel of the hydraulic cylinder 206 to aid in overcoming initial forces required to deploy the RAT.

However, as illustrated in FIGS. 1-2 and described above, the hydraulic actuators 100 and 200 include a plurality of components prone to leakage. Furthermore, the hydraulic actuators 100 and 200 are dependent upon hydraulic fluid within the lines 104-105, and therefore, operation of the hydraulic actuators 100 are further dependent upon fluid temperature, which may be relatively low as compared to average room temperature when operated on an aircraft. Moreover, hydraulic actuators such as actuator 200 require large springs to overcome initial forces in deploying an emergency aircraft power system such as a RAT. During deployment, upon establishment of required momentum to deploy the RAT, the compressed spring and aerodynamic drag forces acting on the deployed portion of the RAT continues to provide additional force which must be absorbed by the actuator snubbing device, RAT and aircraft structure, thereby increasing mechanical strain. Additionally, a mechanical locking device is generally required within the RAT system to prevent “spring back” of the RAT fan under extreme load changes or hard aircraft braking on the ground. Even further, as shown in FIG. 1, hydraulic actuators require both hydraulic and electric componentry in order to operate.

In contrast, exemplary embodiments of the present invention provide electrically actuated emergency aircraft power systems, such as RATs, such that overall weight is reduced (e.g., no hydraulic circuits or mechanical lock are necessary) and less maintenance is required (e.g., no hydraulic leakage inherent in electrical systems).

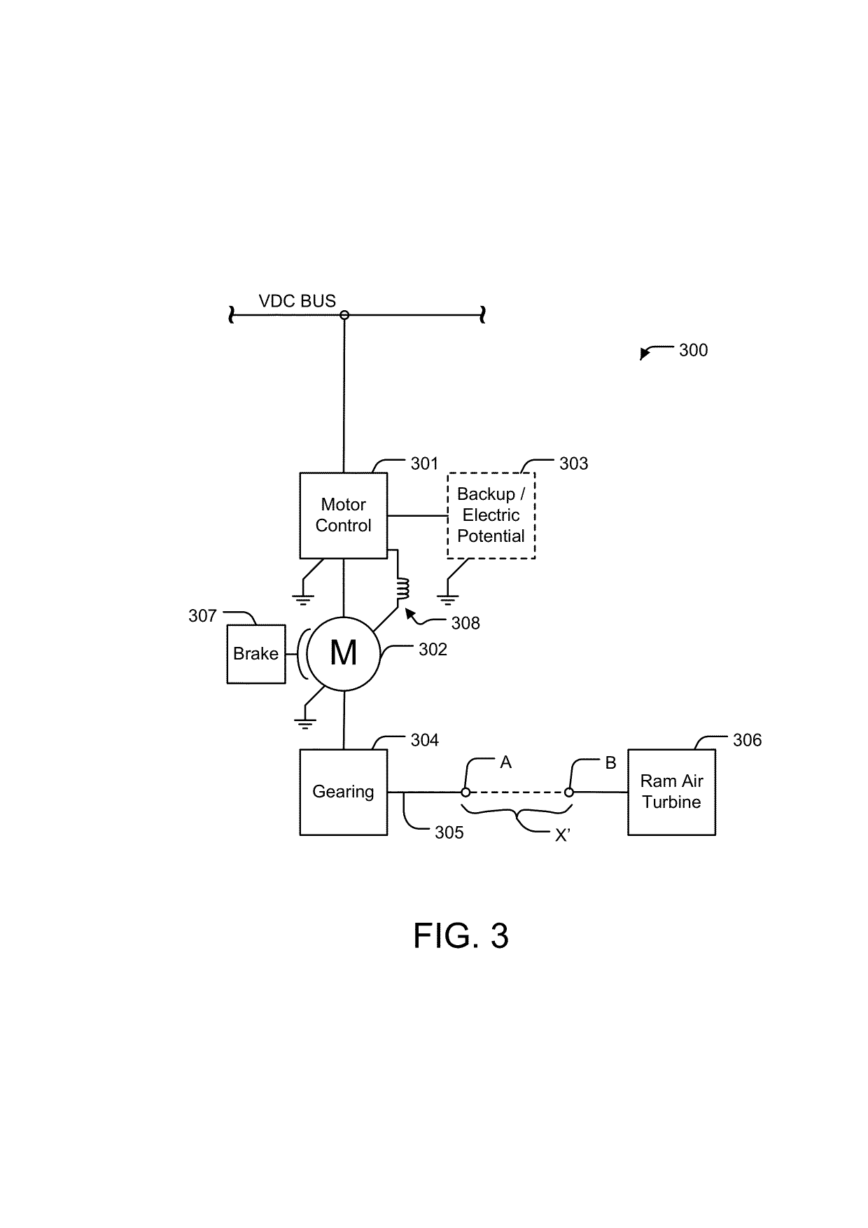

For example, FIG. 3 is a schematic of an electric actuator system for a emergency aircraft power system, according to an exemplary embodiment of the present invention. The system 300 includes a motor control portion 301. The motor control portion 301 is an electrical control system configured to drive a motor 302, for example, by applying an electric current. The motor control portion 301 may be powered by an aircraft's direct current (DC) voltage bus VDC BUS, and may direct DC current and/or residual electric power from the VDC BUS to drive the motor 302 in response to a request or an emergency situation on an aircraft. A motor brake 307 may be included if the deployed RAT loads are sufficiently high to cause the linear actuator to retract and rotate the motor. A resolver 308 may be also included to provide position feedback to the motor controller.

As further illustrated, the system 300 includes backup portion/electric potential 303. As the VDC BUS may be powered by primary aircraft batteries, it may retain some electrical potential with which to drive the motor 302 and brake 307 even during an emergency situation requiring deployment of an emergency aircraft power system such as a RAT. It shall be understood that such an emergency can occur when electrical power is no longer capable of being generated based on motion of the turbine engines of the aircraft, for example. However, under some circumstances, it may beneficial to have an additional source of electric potential. Therefore, the backup portion 303 may include componentry configured to store a suitable electric potential (e.g., transferred from VDC BUS) with which to drive motor 302 in the event of an emergency. Suitable componentry may include a capacitor bank or a battery system.

Turning back to FIG. 3, the system 300 further includes mechanical gearing 304 in mechanical communication with the motor 302. The mechanical gearing 304 may be a set of mechanical components configured to translate the rotating motion of the motor 302 into linear motion of extension member 305 across axis X′, from point A to point B. Suitable mechanical components may include at least one of a screw jack, ball screw, roller screw, travelling nut, rigid chain, and any other suitable components capable of translating rotating motion to linear motion as described. The linear motion is used to deploy RAT 306 from the interior of an aircraft to its exterior, across the axis X′ (e.g., the direction of deployment) where fast air traversing the skin of the aircraft is forced to turn the RAT fan, thereby providing a source of electrical power during an emergency situation.

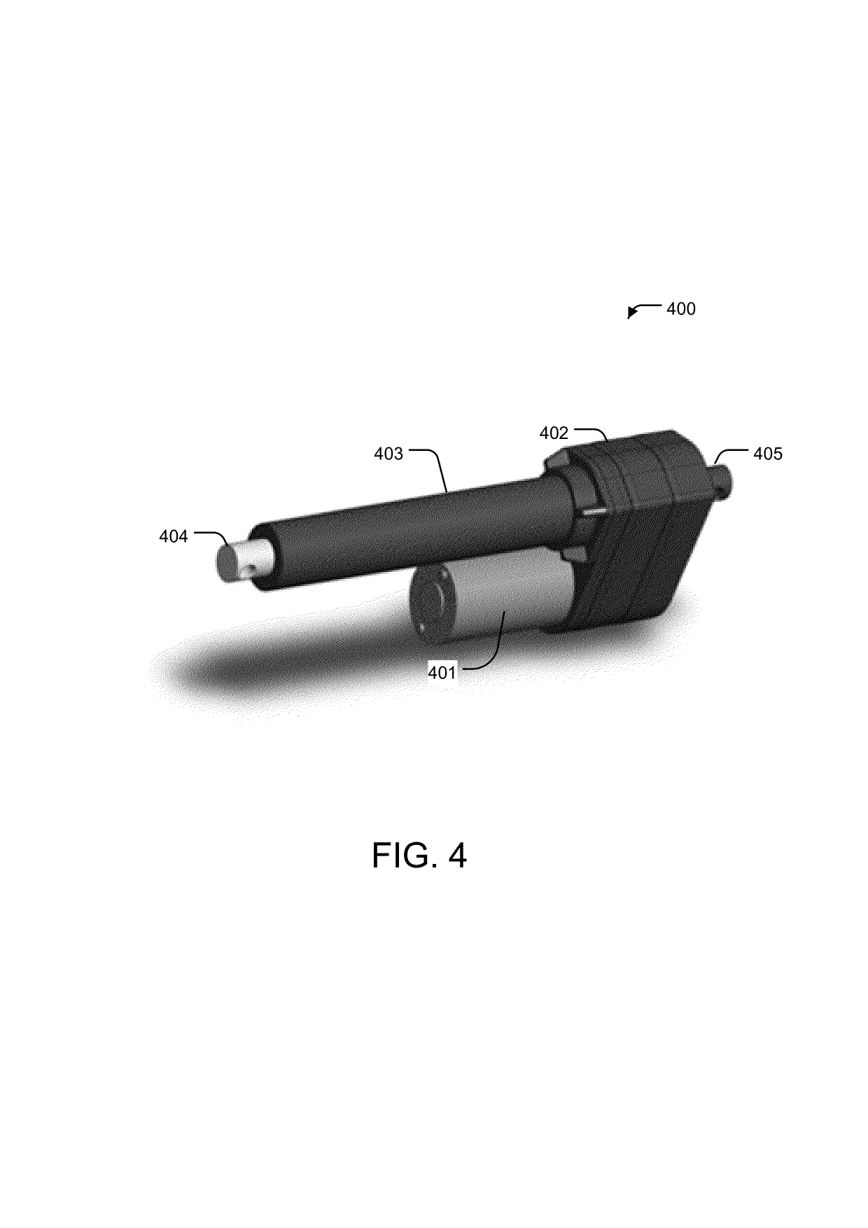

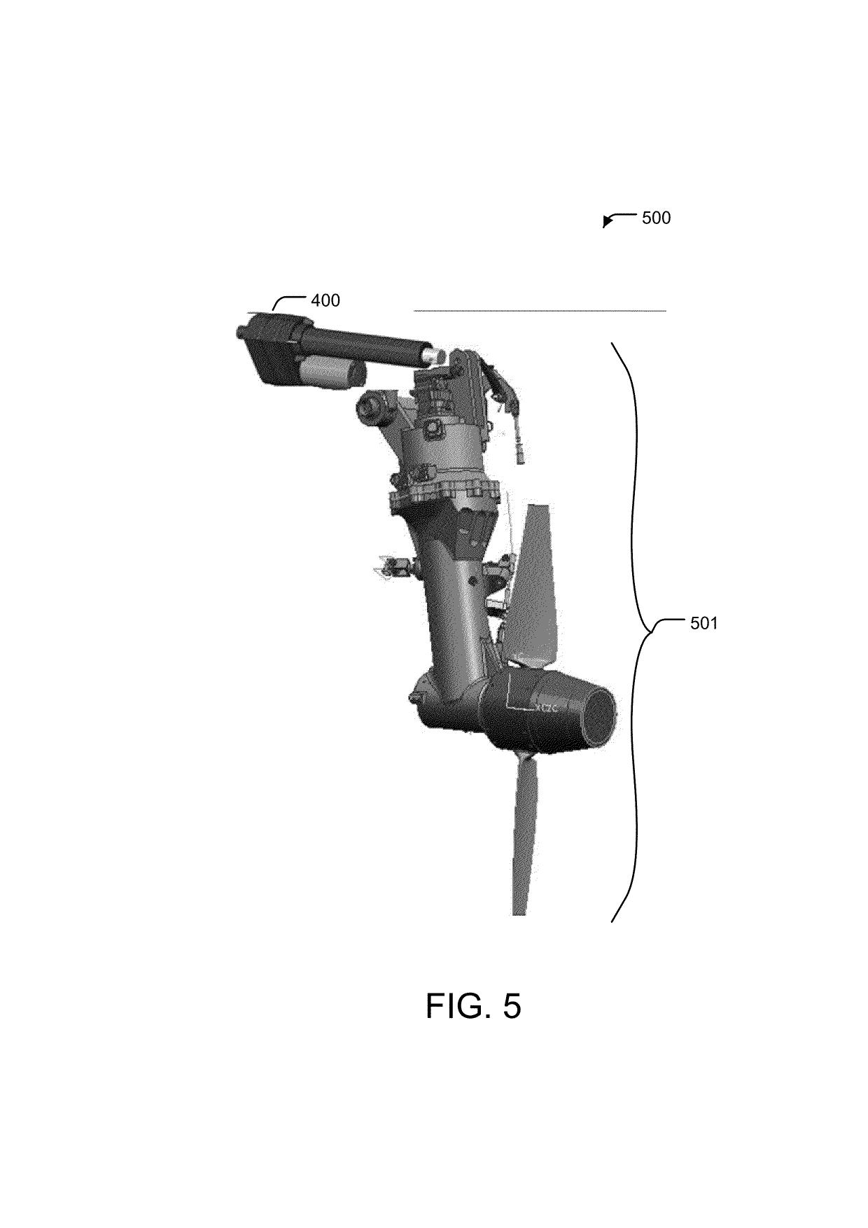

According to at least one exemplary embodiment of the present invention, an appropriate mechanical gearing 304 and motor 302 with brake 307 and resolver 308 are included in actuator 400 illustrated in FIG. 4. As shown, a 28-volt DC motor 401 is in mechanical communication with ball screw gearing 402 to translate rotating motion of the motor 401 into linear motion of the extension member 404 within supporting cylinder 403. Furthermore, optional access nut 405 may be provided to allow actuation using a wrench or other hand tool. The actuator 400 may be integrated with a RAT 501 (e.g., a portion of an emergency power system) as illustrated in FIG. 5, thereby providing an electric actuation system somewhat similar to system 300.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electric actuation system for an emergency power system of an aircraft, comprising:
a motor control portion;
a motor in electrical communication with the motor control portion;
mechanical gearing in mechanical communication with the motor, the mechanical gearing configured to translate rotational motion of the motor into linear motion across at least one axis; and
an extension member in mechanical communication with the mechanical gearing, the extension member configured to linearly travel across the at least one axis.

2. The system of claim 1, wherein the motor control portion is configured to drive the motor using residual power of the aircraft.

3. The system of claim 1, further comprising:
a backup electrical potential storage in electrical communication with the motor control portion, the backup electrical potential storage configured to store electrical energy.

4. The system of claim 3, wherein the motor control portion is configured to drive the motor using the electrical energy stored in the backup electrical potential storage.

5. The system of claim 3, wherein the backup electrical potential storage comprises a capacitor bank.

6. The system of claim 1, wherein the motor is a direct current (DC) motor.

7. The system of claim 6, wherein the motor control portion is configured to drive the DC motor using DC bus power of the aircraft.

8. The system of claim 7, further comprising:
a backup electrical potential storage in electrical communication with the motor control portion, the backup electrical potential storage configured to store electrical energy from the DC bus power of the aircraft.

9. The system of claim 8, wherein the motor control portion is further configured to drive the DC motor using a portion of the electrical energy stored in the backup electrical potential storage.

10. The system of claim 8, wherein the backup electrical potential storage comprises a capacitor bank.

11. The system of claim 6, wherein the motor control portion includes a motor brake to maintain an extended actuator position.

12. The system of claim 1, wherein the mechanical gearing comprises at least one of a screw jack, ball screw, roller screw, travelling nut, and rigid chain.

13. The system of claim 1, further comprising:
a portion of the emergency power system of the aircraft in mechanical communication with the extension member.

14. The system of claim 13, wherein the portion of the emergency power system of the aircraft comprises a fan or turbine.

15. The system of claim 14, wherein the fan is a ram air turbine (RAT) blade-set.

16. The system of claim 15, wherein the at least one axis is a direction of deployment of the RAT.

17. The system of claim 16, wherein the motor control portion is configured to drive the motor in response to a request for RAT power generation or an emergency situation on the aircraft.
